(19) United States
(12) Patent Application Publication
(10) Pub. No.: US 2010/0075179 A1
(43) Pub. Date: Mar. 25, 2010

(54) MASTER DISK FOR TRANSFER AND MANUFACTURING METHOD OF THE SAME

(75) Inventor: Takeo KIDO, Odawara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/563,443

(22) Filed: Sep. 21, 2009

(30) Foreign Application Priority Data
Sep. 19, 2008 (JP) 2008-241173

(51) Int. Cl. C25D 1/00; G11B 5/64

(52) U.S. Cl. 428/826; 205/68

(57) ABSTRACT

A manufacturing method of a master disk for transfer having an uneven pattern corresponding to information to be transferred comprises an initial layer forming step of forming an initial layer containing a nickel film on a surface of a reverse type master disk; an electroforming step of forming a metal layer so as to layer the metal layer on the initial layer by an electroforming method; and a peeling off step of peeling off a duplicated disk having at least two layers that are the initial layer and the metal layer to be integrated from the reverse type master disk after the electroforming step, and obtaining the master disk for transfer that is the duplicated disk with the initial layer being formed by being stacked on an uneven surface of the metal layer.

### BACKGROUND OF THE INVENTION

1. Field of the Invention

The present invention relates to a master disk for transfer and a manufacturing method of the same, and particularly to a master disk for transfer having microscopic uneven patterns on its surface, such as a master disk for magnetic transfer which is used when magnetically transferring magnetic information patterns of format information and the like to a magnetic disk used for a hard disk apparatus, and a mold of a discrete track medium (DTM), and a manufacturing method of the same.

2. Description of the Related Art

Format information and address information are generally written to magnetic disks (hard disks) used for hard disk drives before the magnetic dicks are incorporated into the drives. The write can be performed by a magnetic head, but a collective transfer method by a master disk carrying the format information and address information is efficient and preferable.

The magnetic transfer technique is for transferring the magnetic pattern corresponding to information (for example, a servo signal) which a master disk has by keeping a master disk and a transfer object disk (slave disk) in close contact with each other and placing a magnetic field generating device such as an electromagnet device and a permanent magnet device on one side or both sides of them to apply a magnetic field for transfer.

As one example of a master disk used for such magnetic transfer, there is proposed the one that is made by forming an uneven pattern corresponding to an information signal on the surface of a substrate and forming a thin film magnetic layer to coat the surface of the uneven pattern (for example, see Japanese Patent Application Laid-Open No. 2006-216181).

The uneven pattern of the master disk is made as follows: while a silicon (Si) original plate coated with a photoresist is being rotated, laser or an electron beam modulated in accordance with information is emitted to draw on the original plate, a conductive layer is formed by sputtering or the like on the surface of the original plate having recesses and projections made by developing the photoresist, plating (electroforming) is performed on the conductive layer next to shape a metal, and thereafter the metal disk is peeled off from the Si plate and used as a master disk to duplicate the uneven shape onto the surface of a substrate.

Further, Japanese Patent Application Laid-Open No. 2007-301732 proposes the method relating to manufacture of the mold used for nanoimprint or the like, and having the steps of depositing a material of which adhesion ratio to the surface of a protruded part is lower than the adhesion ratio to the bottom region of a recessed part on a substrate having the uneven pattern by a sputtering method, selectively forming a filling part in the recessed part, thereafter, forming a coating film coating the surface of the protruded part, and peeling off the coating film from the filling part.

### SUMMARY OF THE INVENTION

In a master disk for magnetic transfer, a magnetic layer composed of a substance with high magnetic permeability is necessary. In the art described in Japanese Patent Application Laid-Open No. 2006-216181, the magnetic layer is also used as a conductive layer for performing electroforming.

However, when microfabrication of the uneven patterns of an Si master disk advances, the film forming conditions for obtaining high magnetic permeability and the film forming conditions for making it easy to peel off Ni duplicated disk from the Si master disk are not compatible with each other, and it becomes a problem that the protruded part of an Ni duplicated disk often breaks.

Such a problem is not limited to master disks for magnetic transfer, but is the problem common to the structures having microscopic uneven patterns on the surfaces.

Japanese Patent Application Laid-Open No. 2007-301732 describes the step of electroforming nickel (Ni), but does not describe the physical properties or the like of the metal film which improve peel property.

The present invention is made in view of the above circumstances, and has an object to provide a master disk for transfer with a configuration which easily peels off a duplicated disk from the master disk without breaking microscopic uneven shapes, and a manufacturing method of the same.

In order to attain the above-described object, the present invention provides a manufacturing method of a master disk for transfer having an uneven pattern corresponding to information to be transferred, characterized by including an initial layer forming step of forming an initial layer by a nickel (Ni) film with a density of 8.3 g/cm³ to 8.9 g/cm³ on a surface of a reverse type master disk having a reverse uneven pattern, an electroforming step of forming a metal layer so as to layer the metal layer on the initial layer of the reverse type master disk by an electroforming method after forming the initial layer, and a peeling off step of peeling off a duplicated disk having at least two layers that are the initial layer and the metal layer to be integrated from the reverse type master disk after the electroforming step, and obtaining the master disk for transfer that is the duplicated disk with the initial layer being formed by being stacked on an uneven surface of the metal layer.

According to the present invention, the initial layer of the conductive film (Ni film) with a density of 8.3 to 8.9 g/cm³ is present. Therefore, peel property of the duplicated disk (electroformed object) is enhanced, breakage of the protruded part is prevented, and the master disk for transfer with high form stability can be obtained. A metal layer may be directly formed on the initial layer by electroforming, and the metal layer may be formed after an intermediate layer such as a magnetic layer is formed on the initial layer.

“Transfer master disk” includes various master disks such as a master disk for magnetic transfer, a mold for manufacture of a discrete track medium, and a stamper for manufacture of an optical disk or the like.

The manufacturing method of a master disk for transfer according to another embodiment of the present invention is characterized in that after formation of the initial layer, a main layer formation is performed in a main layer forming step of forming a main layer having magnetism on a surface of the initial layer of the reverse type master disk, after formation of the main layer, electroforming is performed in the electroforming step, and by the peeling off step, the master disk for transfer which is the duplicated disk with the main layer and the initial layer being formed by being stacked on the uneven surface of the metal layer is obtained.

According to such an embodiment, a master disk for magnetic transfer with the configuration in which the master disk and the duplicated disk are easily peeled off from each other while the magnetic permeability of the magnetic layer (main layer) suitable for magnetic transfer is maintained.

Further, the present invention provides a master disk for transfer having an uneven pattern corresponding to information to be transferred, characterized in that on an uneven pattern of a metal disk formed by electroforming, an initial layer of a nickel (Ni) film with a density of 8.3 g/cm³ to 8.9 g/cm³ to be a conductive layer at a time of performing the electroforming is formed by being stacked.

The master disk for transfer of the present invention is the one with the uneven shape of the mother die used for electroforming being accurately reproduced, and can realize transfer with high quality.

In the present invention, a film thickness of the initial layer is preferably 1 nm to 100 nm.

According to the present invention, the uneven pattern of the microscopic shape can be formed with high precision, and therefore, the master disk for transfer excellent in transfer property can be obtained. Further, by using the master disk for transfer according to the present invention, transfer with stable quality can be realized.

### BRIEF DESCRIPTION OF THE DRAWINGS

FIG. 1 is a partially enlarged perspective view of a master disk for magnetic transfer according to an embodiment of the present invention;

FIG. 2 is a plane view of the master disk for magnetic transfer;

FIGS. 3A to 3I are sectional views showing a manufacture process of the master disk for magnetic transfer in sequence;

FIG. 4 is an explanatory view concerning the definition of a trapezoidal shape of the protruded part of a duplicated disk;

FIG. 5 is a graph of an experimental result of examining the relationship of the density of an Ni initial layer and pattern formability;

FIG. 6 is a diagram summarizing the state of the line pattern obtained in the experiment for examining the relationship of the density of the Ni initial layer and pattern formability;

FIG. 7 is an explanatory view of magnetic transfer according to a horizontal magnetizing method;

FIG. 8 is a diagram showing an example of a reproduction signal waveform of a perpendicular magnetic recording medium for which magnetic transfer is performed by the horizontal magnetizing method;

FIG. 9 is an explanatory view of magnetic transfer by a perpendicular magnetizing method; and

FIG. 10 is a diagram showing an example of the reproduction signal waveform of the perpendicular magnetic recording medium for which magnetic transfer is performed by the perpendicular magnetizing method.

### DETAILED DESCRIPTION OF THE PREFERRED EMBODIMENT(S)

Hereinafter, a preferred embodiment of the present invention will be described in detail in accordance with the accompanying drawings.

Here, as one example of a master disk for transfer, a master disk for magnetic transfer will be described as an example.

[Description of Master Disk]

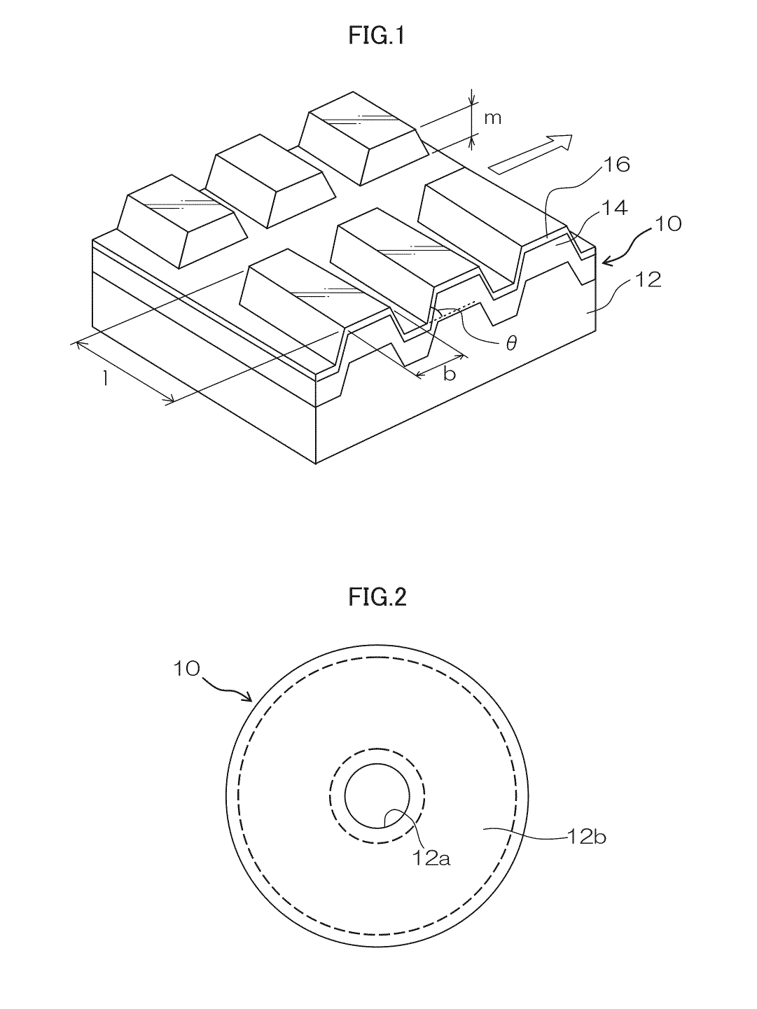

FIG. 1 is a partially enlarged perspective view of a master disk for magnetic transfer according to the embodiment of the present invention. FIG. 2 is a plane view of a master disk for magnetic transfer. Each of the drawings is illustrated in the dimensional ratio different from the actual dimensional ratio for convenience of description.

As shown in FIG. 1, a master disk for magnetic transfer (hereinafter, called “master disk”) 10 according to the present embodiment is configured by a metal master substrate 12 (corresponding to “metal layer” and “metal disk”), a magnetic layer 14 (corresponding to “main layer”) and an initial layer 16. The master substrate 12 has microscopic uneven patterns corresponding to transfer information on the surface, the magnetic layer 14 is formed and coated on the surfaces of the uneven patterns, and the initial layer 16 is further formed and coated on the magnetic layer 14. Though not illustrated in the drawing, the mode of providing a protection layer and a lubrication layer on the initial layer 16 is preferable.

The protruded part of the microscopic protruded pattern is rectangular in plane view, and the values of a length b in the track direction (direction of the thick arrow in the drawing), a length 1 in the radius direction and a height (thickness) m of the protrusion are designed in accordance with a recording density, a recording signal waveform and the like. For example, the length b can be set to 80 nm, and the length 1 can be set to 200 nm.

In the case of the servo signal of the magnetic recording medium used for a hard disk apparatus, the microscopic protruded pattern is formed so that the length 1 in the radius direction is longer as compared with the length b in the track direction. For example, it is preferable that the length 1 in the radius direction is 0.05 to 20 μm, and the length in the track direction (circumferential direction) is 0.05 to 5 μm. Selecting the pattern longer in the radius direction in this range is preferable as the pattern for carrying the information of a servo signal.

The depth of the protruded pattern (height m of the protrusion) is preferably in the range of 20 to 800 nm, and more preferably in the range of 30 to 600 nm.

As shown in FIG. 2, the master disk 10 is formed into a disk shape having a center hole 12a, and the uneven pattern as in FIG. 1 is formed in a circular area 12b except for an inner circumferential part and an outside diameter part of one side.

When the master substrate 12 is a ferromagnetic substance mainly composed of Ni or the like in the master disk 10, magnetic transfer can be performed with only the master substrate 12, and the magnetic layer 14 does not have to be coated thereon, but by providing the magnetic layer 14 with favorable transfer characteristics, more favorable magnetic transfer can be performed.

The master disk 10 of this embodiment is manufactured by forming the initial layer 16 and the magnetic layer 14 on the master disk (reverse type master disk) on which an uneven pattern corresponding to the information to be transferred is formed, stacking a metal layer (metal disk corresponding to the master substrate 12) with a predetermined thickness by Ni electroforming next, peeling off the duplicated disk of the electroformed product with the initial layer 16, the magnetic layer 14 and the metal layer (master substrate 12) being integrated from the master disk, and thereafter, having the outer circumferential part and the center hole 12a part stamped out in desired sizes.

[Description of Manufacturing Method of Master Disk}

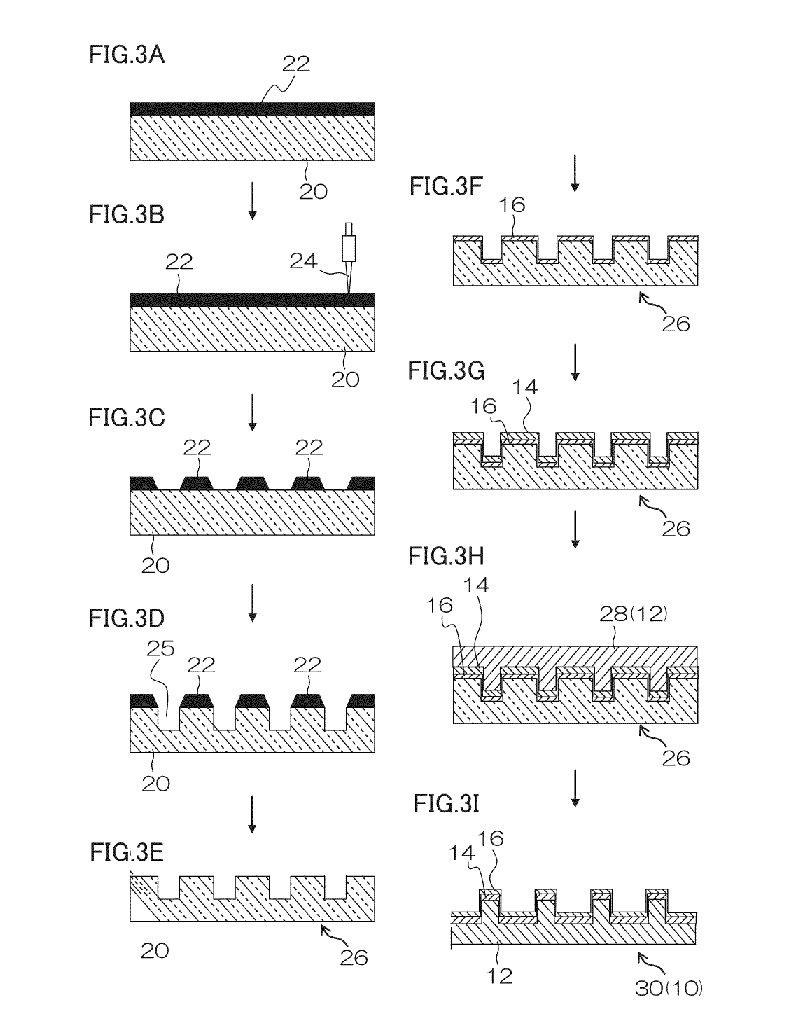

Next, a manufacturing method of the master disk 10 will be described based on FIGS. 3A to 3I. First, as shown in FIG. 3A, an electron beam resist solution is coated onto an original plate 20 (a glass plate and a quartz glass plate may be applicable) which is a silicon wafer with a smooth surface by a spin coat method or the like (resist coating step), and a resist layer 22 is formed, and baking processing (prebake) is performed.

Next, the original plate 20 is set on a stage of an electron beam aligner not illustrated including a highly precise rotary stage or X-Y stage, and while the original plate 20 is rotated, an electron beam 24 modulated to correspond to a servo signal is irradiated to the original plate 20 (FIG. 3B). A predetermined pattern, for example, a pattern corresponding to a servo signal which extends linearly in a radius direction from a rotational center in each track is drawn and exposed in a portion corresponding to each frame on the circumference over the substantially entire surface of the resist layer 22 (electron beam lithography step).

Next, as shown in FIG. 3C, the resist layer 22 is developed, the exposed portions are removed, and the remaining resist layer 22 forms a coating layer with a desired thickness. The coating layer forms a mask for the next step (etching step). After development, baking (postbake) is performed for enhancing the adhesion of the resist layer 22 and the original plate 20.

Next, as shown in FIG. 3D, the original plate 20 is removed (etched) by a predetermined depth from the surface from an opening 25 of the resist layer 22. In the etching, anisotropic etching is desirable to minimize the undercut (side etch). As such anisotropic etching, reactive ion etching (RIE; Reactive Ion Etching) can be preferably adopted.

Next, as shown in FIG. 3E, the resist layer 22 is removed. As the removal method of the resist layer 22, ashing can be adopted as a dry method, and a removal method by a stripping solution can be adopted as a wet method. By the above ashing step, a master disk 26 (Si master disk corresponding to “reverse type master disk”) on which the reversed shape of the desired uneven pattern is formed is produced.

Next, as shown in FIG. 3F, the initial layer 16 of a conductive film is formed to a uniform thickness on the uneven surface of the master disk 26. As the forming method of the conductive film, various metal depositing methods and the like including PVD (Physical Vapor Deposition), CVD (Chemical Vapor Deposition), sputtering, and ion plating can be applied. In the present embodiment, as the conductive film of the initial layer 16, an Ni film is formed by a sputtering method. Such a film mainly composed of Ni is easy to form and suitable as the conductive film.

The film thickness of the initial layer 16 is 1 to 100 nm, preferably 1 to 50 nm, and especially preferably 2 to 20 nm. If the initial layer 16 of Ni becomes too thick, the recessed defect tends to occur on the surface of the duplicated disk, and therefore, the film thickness is desirably made the minimum required thickness.

Further, the density of the Ni film composing the initial layer 16 is set in the range of 8.3 to 8.9 g/cm³. The density is more preferably 8.4 to 8.9 g/cm³, and especially preferably 8.5 to 8.8 g/cm³.

Next, as shown in FIG. 3G, the magnetic layer 14 (main layer) containing a magnetic film is formed on the initial layer 16. For formation of the magnetic layer 14 (magnetic film), a magnetic material is deposited by vacuum deposition means such as a vacuum deposition method, a sputtering method and an ion plating method, a plating method (including electroless plating) or the like. As the magnetic material of the magnetic layer 14, Co, a Co alloy (CoNi, CoNiZr, CoNbTaZSr and the like), Fe, an Fe alloy (FeCo, FeCoNi, FeNiMo, FeAlSi, FeAl, FeTaN), Ni, and an Ni alloy (NiFe) can be used.

FeCo and FeCoNi can be especially used preferably. The thickness of the magnetic layer 14 is preferably in the range of 50 nm to 500 nm.

Next, as shown in FIG. 3H, electroforming (electrodeposition) is performed by using the conductive layer composed of the initial layer 16 formed on the surface of the master disk 26 and the magnetic layer 14 as a cathode to form a metal layer 28 with a desired thickness (Ni electroformed film in this case), and the metal plate corresponding to the master substrate 12 described in FIG. 1 is obtained (electroforming step).

The electroforming step is performed by immersing the master disk 26 in the electrolytic solution of an electroforming apparatus, using the conductive layer (initial layer 16 and the magnetic layer 14) of the master disk 26 as the cathode, and passing an electric current between the cathode and an anode. The electroforming is required to be carried out under the optimal conditions of the concentration and pH of the electrolytic solution, application of the electric current and the like at this time under which the metal plate (namely, the master substrate 12) to be formed has no distortion.

Subsequently, after electrodeposition is finished as described above, the master disk 26 on which the metal layer 28 with a predetermined thickness is stacked is taken out of the electrolytic solution of the electroforming apparatus, and is immersed in pure water in a releasing tank (not illustrated).

Next, in the releasing tank, an electroformed product (duplicated disk 30) in which the initial layer 16, the magnetic layer 14 and the metal layer 28 are integrated is peeled off from the master disk 26 (peeling off step), and the duplicated disk 30 having the uneven pattern reversed from those of the master disk 26 as shown in FIG. 3I is obtained.

When a protection layer is formed on the initial layer 16, the duplicated disk 30 is peeled off from the master disk 26, and thereafter, a carbon film is formed by a sputtering method on the master disk 10 obtained by stamping out the inside diameter and the outside diameter of the duplicated disk 30 into predetermined sizes.

Thus, the master disk 10 for magnetic transfer is manufactured.

When the magnetic strength is desired to be large, the duplicated disk 30 is peeled off from the master disk 26, and thereafter, a magnetic layer is formed (mounted later) once again on the master disk 10 obtained by stamping out the inside diameter and the outside diameter of the duplicated disk 30 into predetermined sizes, after which, a protection layer is formed.

According to the above described manufacturing method, peel property of the duplicated disk 30 in the peeing off step is favorable, and the pattern breakage of the protruded part can be prevented. Thereby, the master disk 10 for magnetic transfer with the uneven shape of the master disk 26 accurately reproduced can be obtained, and magnetic transfer with favorable signal quality is enabled.

Further, as shown in FIG. 1, the protruded part of the protruded pattern in the master disk 10 is a trapezoid in side view, and as an angle θ of the protruded part in FIG. 1 is closer to 90 degrees (as the shape of the protruded part in side view is closer to a rectangle), the duplicated disk 30 becomes more difficult to peel off from the master disk 26.

According to the manufacturing method of this embodiment, the peel property of the duplicated disk 30 is improved as compared with the conventional one. Therefore, the shape of the protruded part can be made close to a rectangle, and high density and high precision of the pattern can be realized.

Further, according to the manufacturing method of the present embodiment, one master disk 26 can be repeatedly used, and a plurality of duplicated disks can be manufactured with one master disk 26.

[Preferable Mode of Trapezoidal Shape of the Protruded Part in a Duplicated Disk]

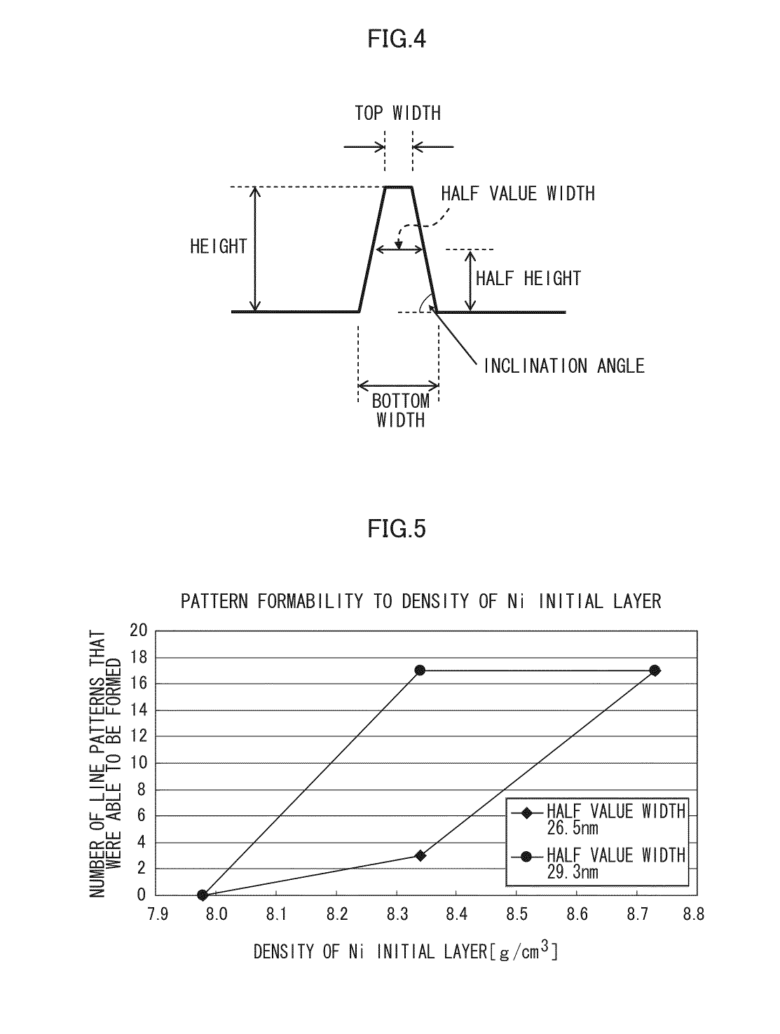

FIG. 4 is a schematic diagram of the trapezoidal shape of the protruded part of the Ni duplicated disk. As shown in the diagram, “height” and “half value width” of the protruded part, and “inclination angle” of the inclined plane of the trapezoid are defined. The half value width is the width of the protruded part in the position at half the height. Further, the aspect ratio of the trapezoidal shape of the protruded part is defined as “height/half value width”.

As for preferable ranges of the height and the half value width in the present embodiment, the range of the height is 5 to 800 nm, and the range of the half value width is 3 to 20000 nm. More preferable ranges are 10 to 600 nm for the height, and 7 to 5000 nm for the half value width. Especially preferable ranges are 20 to 400 nm for the height, and 10 to 500 nm for the half value width. More specifically, a plurality of protruded part patterns, for example, with the heights of 100 nm and the half value widths of 40 nm to 250 nm are present in the same duplicated disk.

Preferable ranges of the height and half value width of the duplicated disk in the present embodiment are 5 to 800 nm for the height, and 3 to 20000 nm for the half value width. More preferable ranges are 10 to 600 nm for the height, and 7 to 5000 nm for the half value width. Especially preferable ranges are 20 to 400 nm for the height, and 10 to 500 nm for the half value width.

More specifically, a plurality of protruded part patterns, for example, with the heights of 100 nm and the half value widths of 40 nm to 250 nm are present in the same duplicated disk.

A preferable range of the aspect ratio is 0.05 to 50.0. More preferable range is 0.02 to 10.0. Especially preferable range is 0.2 to 5.0. More specifically, a plurality of the protruded part patterns, for example, with the aspect ratios of 0.5 (=100/250) to 2.5 (=100/40) are present in the same duplicated disk.

The preferable range of the inclination angle of the inclined plane of the trapezoid is 20 to 90°. More preferable range is 30 to 89°. Especially preferable range is 40 to 88°. More specifically, the inclination angle is designed to be about 82°, for example.

Peel property of the duplicated disks is further enhanced if the bottom portion of the protruded shape is formed into a trailing shape (rounded) instead of a strictly trapezoidal shape.

The trapezoidal shape of the protruded part pattern in the duplicated disk can be realized by RIE (Reactive Ion Etching). The inclination angle of the trapezoidal shape is controlled by changing the etching rate, and the kind, the mixture ratio and the like of the etching gases.

[Physical Property of Initial Layer (Ni film)]

In the manufacturing process of the master disk 10 described with FIGS. 3A to 3I, peel property at the time of peeling off the duplicated disk 30 from the master disk 26 after the electroforming step, that is, the formability of the uneven pattern in the duplicated disk 30 depends on the physical property of the initial layer 16.

FIG. 5 is an experimental result of examining the relationship of the density of the Ni film and pattern formability. In this experiment, Ni electroforming is directly performed on the Ni initial layer (film thickness=9 nm), and pattern formability is evaluated for the obtained duplicated disk (corresponding to “master disk for transfer”). Specifically, the uneven pattern structure is formed by the Ni initial layer and the Ni electroformed layer without including the magnetic layer (main layer) 14 described in FIGS. 1 and 3, and the pattern formability is evaluated with the layer configuration of the “Ni initial layer/Ni electroformed layer”.

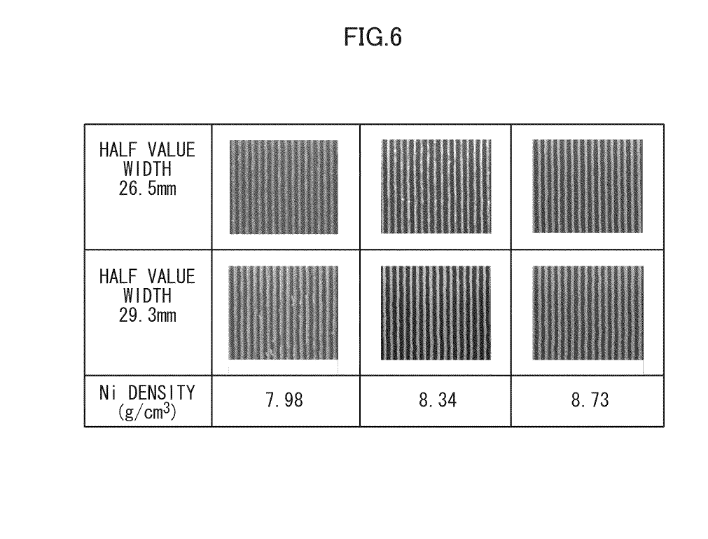

In the experiment, 17 of the line patterns (protruded parts) each with a height of 60 nm were equidistantly formed by causing the densities of the Ni initial layers to differ from one another, and the number of line patterns which were able to be favorably formed was found. The results in the case of forming the line pattern with a half value width of 26.5 nm and in the case of forming the line pattern with a half value width of 29.3 nm are shown in Table 1 and FIG. 5. Further, the state of the line pattern obtained in each of the experiments is summarized in FIG. 6.

TABLE 1

| Ni DENSITY | HALF VALUE WIDTH | HALF VALUE WIDTH |
|---|---|---|
| (g/cm³) | 26.5 nm | 29.3 nm |
| 7.98 | 0 | 0 |
| 8.34 | 3 | 17 |
| 8.73 | 17 | 17 |

The physical properties (density, stress, hardness and the like) of the Ni film are changed in accordance with the depositing conditions (power of the Ni sputtering device, film forming pressure and the like) of the Ni initial layer.

From the experimental results, the density of the Ni initial layer is desirably set to 8.34 g/cm³ or more. Further, the bulk density of Ni is 8.9 g/cm³, and therefore, the upper limit of the density is 8.9 g/cm³.

More specifically, the density of the Ni film composing the initial layer 16 is in the range of 8.3 to 8.9 g/cm³. The density range is more preferably 8.4 to 8.9 g/cm³, and is especially preferably 8.5 to 8.8 g/cm³.

As the experimental result shows, as the density of the Ni initial layer is higher, the pattern formability of the duplicated disk becomes better. Further, as the line width of the pattern becomes finer, a larger effect is obtained.

When the experiment was performed by variously changing the physical properties of the initial layer, the Ni film with good peel property (pattern formability) shows the tendencies of [1] high density (close to bulk density), [2] large stress and [39 high hardness.

Further, when the similar experiment was carried out about the composition with the magnetic layer (main layer) 14 described in FIG. 1 and FIGS. 3A to 3I being added, the similar result was obtained (not illustrated). More specifically, about the uneven pattern structure formed by the layer composition of the Ni initial layer/FeCo main layer/Ni electroformed layer, the similar result to that of FIG. 5 was also obtained when the pattern formability similar to the above description was evaluated. Presence and absence of the magnetic layer (main layer) 14 less contribute to releasablity (pattern formability), and the physical properties of the initial layer can be said to contribute greatly to peel property (pattern formability).

### Example

The initial layer of a thickness of 9 nm containing Ni with a density of 8.7 g/cm³ was formed by a sputtering method on the surface of the Si mater disk (corresponding to “reverse type master disk”) on which a number of microscopic uneven patterns were formed, and then the main layer of a thickness of 60 nm containing FeCo and having magnetism was formed by the sputtering method again. By electroforming Ni on the surface of the Si master disk on which the conductive layer containing two layers that are the Ni initial layer (9 nm) and the FeCo main layer (60 nm) is formed, the Ni duplicated disk with a thickness of 150 μm was formed. By peeling off the duplicated disk from the Si master disk, the master disk for magnetic transfer which is the reverse plate having the reverse pattern of the uneven shapes on the surface and having the magnetic layer formed on the surface of the reverse pattern is obtained.

By using the Ni initial layer of the above conditions, the master disk with favorable form stability (without breakage of the uneven pattern) can be produced.

[Description of Magnetic Transfer Method]

Next, a magnetic transfer method using the master disk 10 for magnetic transfer according to the present embodiment will be described. In this case, the case of transferring a servo signal and the like to the perpendicular magnetic recording medium used for a hard disk apparatus will be shown as an example.

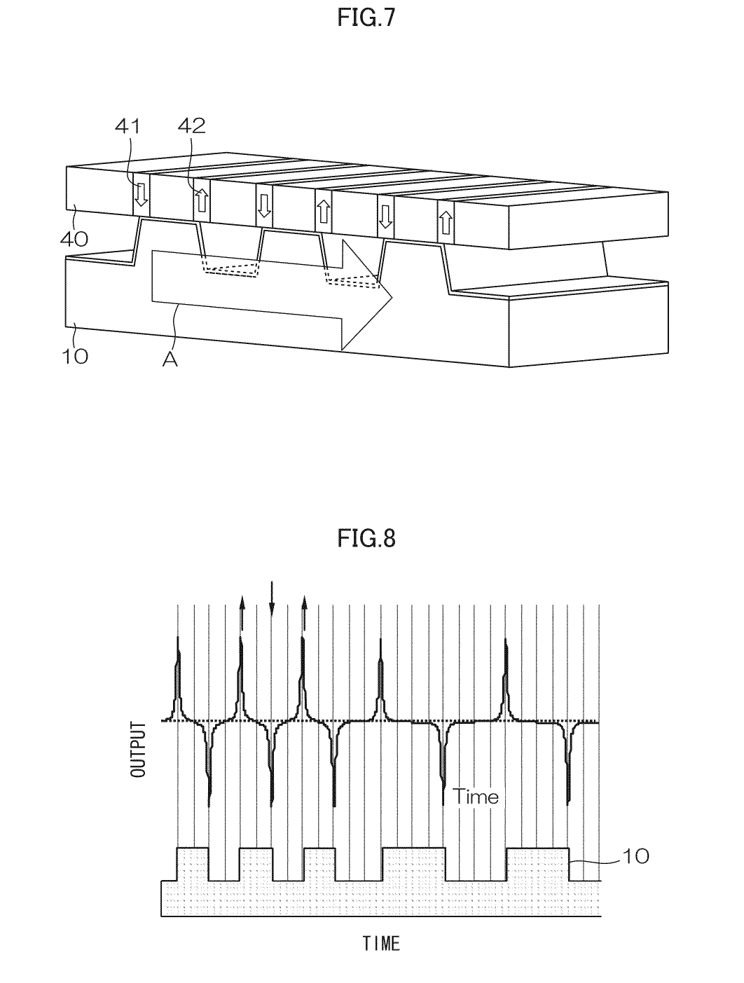

FIG. 7 is a schematic view of the magnetic transfer method according to a horizontal magnetizing method. In FIG. 7, reference numeral 40 designates a slave dick (perpendicular magnetic recording medium) as a magnetic disk for having transfer. In the master disk 10, a transfer image carrying surface with microscopic protruded patterns formed is formed on one surface, and a surface (undersurface side) at a side opposite from the transfer information carrying surface is held by a close contact device not illustrated.

At the time of magnetic transfer, the transfer information carrying surface of the master disk 10 is brought into close contact with the slave disk 40, and a magnetic field in an in-plane direction (arrow A direction of FIG. 7) is applied to the master disk 10. By application of the in-plane magnetic field, the magnetic field in the perpendicular direction occurs to the edge portions of the protruded parts of the master disk 10. By the magnetic field in the perpendicular direction, the magnetic layer of the slave disk 40 at the positions corresponding to the edge positions of the protruded parts are magnetized in the perpendicular direction. Arrows with reference numerals 41 and 42 in FIG. 7 schematically show the directions of the magnetization.

In this manner, the magnetic information reflecting the uneven patterns of the master disk 10 is recorded in the slave disk 40. Thereafter, applying the magnetic field is stopped, then the slave disk 40 is released from the master disk 10, and the perpendicular magnetic recording medium on which a servo signals and the like are recorded is obtained.

FIG. 8 shows a waveform example of the reproduction (output) signal of the signal recorded in the slave disk 40 by magnetic transfer of the horizontal magnetizing method described with FIG. 7. As in FIG. 8, a reproduction signal in which the peaks appear at the positions of the slave disk 40 corresponding to the edges (boundary portions of recesses and protrusions) of the protruded parts of the master disk 10 is obtained.

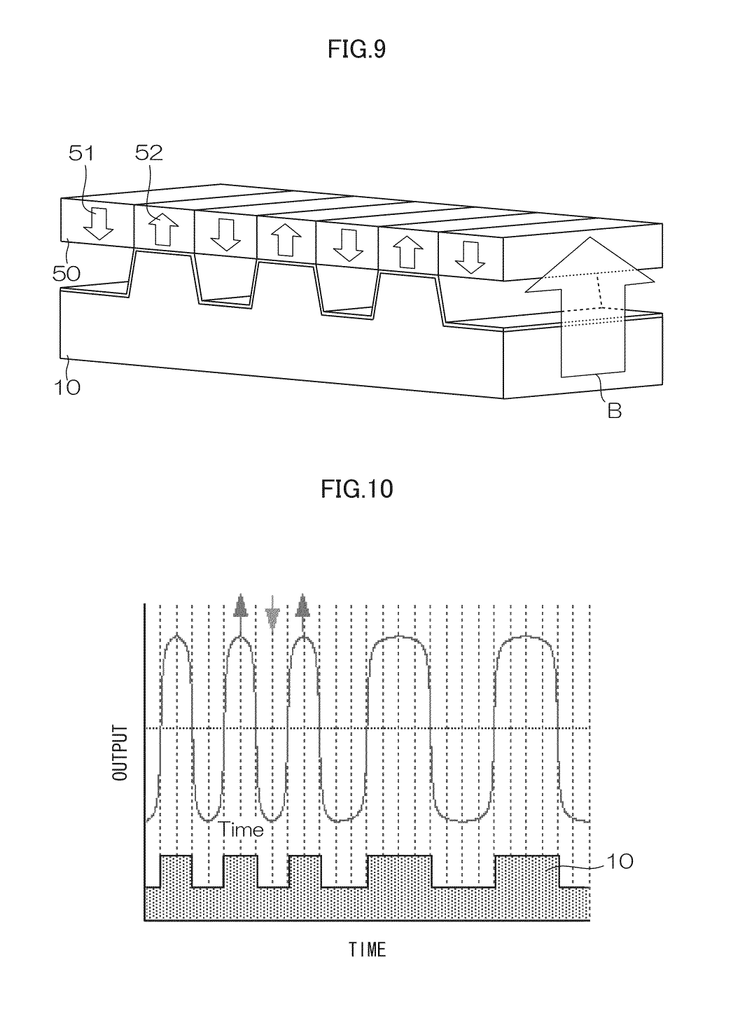

FIG. 9 is a schematic view of a magnetic transfer method according to a perpendicular magnetizing method. In FIG. 9, reference numeral 50 designates a slave disk (perpendicular magnetic recording medium) as the magnetic disk for having transfer. In the case of the perpendicular magnetizing method, initial magnetization is performed by applying a direct-current magnetic field in the perpendicular direction to the slave disk 50 in advance prior to transfer (initial magnetizing process). Thereafter, as in FIG. 9, the master disk 10 and the slave disk 50 are brought into close contact with each other, and the magnetic field in the perpendicular direction (magnetic field in the arrow B direction) in the direction opposite from the direction at the time of initial magnetization is applied. By application of the magnetic field, the magnetic layer of the slave disk 50 at the positions in contact with the protruded parts of the master disk 10 is magnetized in the direction opposite from the initial magnetization. The arrows of the reference numerals in FIG. 9 schematically show the directions of magnetization.

In this manner, the magnetization information reflecting the uneven patterns of the master disk 10 is recorded in the slave disk 50. Thereafter, applying the magnetic field is stopped then the slave disk 50 is released from the master disk 10, and the perpendicular magnetic recording medium in which a servo signal and the like are recorded is obtained.

FIG. 10 shows a waveform example of the reproduction (output) signal of the signal recorded in the slave disk 40 by magnetic transfer of the perpendicular magnetization method described in FIG. 9. As shown in FIG. 10, the reproduction signal in which peaks appear at the positions of the slave disk 40 corresponding to the centers of the protruded parts and the centers of the recessed parts of the master disk 10 is obtained.

Even when the uneven patterns of the master disk 10 are the negative patterns in the uneven shape opposite from the positive patterns of FIG. 3I, similar magnetization patterns can be transferred and recorded by making the direction of the initial magnetic field Hi and the direction of the magnetic field Hd for transfer at the time of magnetic transfer to be the reverse directions from this.

By performing magnetic transfer using the master disk 10 according to the present invention, a magnetic recording medium in which a servo signal and the like with favorable signal quality are recorded can be manufactured.

The master disk for magnetic transfer is described as an example in the above described embodiment, but the application range of the present invention is not limited to this, and the present invention can be applied to master disks for various purposes such as a mold (DTM mold) used for manufacture of a discrete track medium (DTM), a stamper used for manufacture of an optical disk or the like.

What is claimed is:

1. A manufacturing method of a master disk for transfer having an uneven pattern corresponding to information to be transferred, comprising:
an initial layer forming step of forming an initial layer containing a nickel (Ni) film with a density of 8.3 g/cm³ to 8.9 g/cm³ on a surface of a reverse type master disk having a reverse uneven pattern;
an electroforming step of forming a metal layer so as to layer the metal layer on the initial layer of the reverse type master disk by an electroforming method after forming the initial layer; and
a peeling off step of peeling off a duplicated disk having at least two layers that are the initial layer and the metal layer to be integrated from the reverse type master disk after the electroforming step so as to obtain the master disk for transfer that is the duplicated disk with the initial layer being formed by being stacked on an uneven surface of the metal layer.

2. The manufacturing method of a master disk for transfer according to claim 1, further comprising:
a main layer forming step of forming a main layer having magnetism on a surface of the initial layer of the reverse type master disk, after formation of the initial layer;
wherein, after formation of the main layer, electroforming is performed in the electroforming step; and
the master disk for transfer which is the duplicated disk with the main layer and the initial layer being formed by being stacked on the uneven surface of the metal layer is obtained in the peeling off step.

3. A master disk for transfer comprising:
a metal disk which is formed by electroforming;
an uneven pattern which is formed on the surface of the metal disk and corresponds to information to be transferred;
an initial layer which is stacked and formed on the uneven pattern, containing a nickel (Ni) film with a density of 8.3 g/cm³ to 8.9 g/cm³ and used to be a conductive layer at a time of performing the electroforming.

4. The master disk for transfer according to claim 3, further comprising;
a main layer which has magnetism and is formed on the uneven pattern of the metal disk;
wherein the initial layer is formed on the main layer.

5. The master disk for transfer according to claim 3,
wherein a film thickness of the initial layer is 1 nm to 100 nm.
